(19) United States
(12) Patent Application Publication
(10) Pub. No.: US 2006/0246235 A1
(43) Pub. Date: Nov. 2, 2006

(54) Foldable Christmas tree

(76) Inventor: Bell Lin, Highland, CA (US)

Correspondence Address: Raymond Y. Chan, 108 N. Ynez Ave., #128, Monterey Park, CA, 91754, US

(21) Appl. No.: 11/117,799

(22) Filed: Apr. 28, 2005

(51) Int. Cl. G09F 19/00; A41G 1/00

(52) U.S. Cl. 428/18; 428/20; 428/9

(57) ABSTRACT

The present invention discloses a foldable Christmas tree, which comprises a tree body having at least two leaf panels, each of which comprises a longitudinal inner side, a tipped top end, a base portion, and a shaped outer side; means for hanging the leaf panel at the inner side thereof in such a manner the outer side of the leaf panel is capable of pivotally folding along the inner side of the leaf panel for storage and is capable of radially disposing with respect to the inner side of leaf panel for erecting the tree body; and means for binding the leaf panels at the outer side thereof so as to retain an angular angle between any two of the leaf panels.

### BACKGROUND OF THE PRESENT INVENTION

1. Field of Invention

The present invention relates to an artificial Christmas tree, more particularly, relates to a foldable decorative tree which is steadfastly stable, easy to assemble and disassemble, compact to store, quick to erect and set up, and aesthetically appealing.

2. Description of Related Arts

Christmas tree is an essential ingredient of a happy Christmas. Nowadays, more and more people choose artificial Christmas trees for adorning their house in the holiday season. Compared with real Christmas trees, artificial Christmas trees offer some distinctive advantages. For instance, an artificial tree can last for many years and a live tree is only chopped down for the Christmas season only to be burned and tossed away after Christmas. Also, an artificial tree does not have a smell. Furthermore, an artificial tree is easy to set up and it never shed pine needles all over the floor and carpet.

However, the artificial Christmas trees available on the market nowadays suffer several drawbacks. First of all, artificial trees are dense with fade-resistant, crush resistance PVC needles that have thicker ply to keep their shape year after year.

Second, difficulty in storing artificial trees often leads to the artificial tree being damaged. Damage can range from broken branches, loss of pins, or branches bent out of position, giving the tree an unnatural look. Commonly, a larger storage space is required.

Third, artificial trees can only be positioned in places which allow for the full circumference and size of the model. This further limits the places in which one would wish to place an artificial tree.

Fourth, since the artificial trees are designed to be set up in application and be disassembled after use, so that all components of the artificial tree, such as trunk, branches, and decorative ornaments are designed to be interconnected or coupled together for application and separated in storage. Unfortunately, it is time consuming and bored to set up an artificial tree with a lot of components.

Fifth, to ensure the artificial trees are immoveable and steadfastly stable, commonly, a rather heavy base is employed for providing some weight support. So the artificial trees are inevitably bulky and awkward.

Sixth, an artificial Christmas tree as well as a real Christmas tree is formed of a tapered conical-shape, which is not adaptive for being hanged on a wall or disposed into a corner.

Finally, to attach some decorative ornaments on an artificial Christmas tree, a very long wire is provided for helically encircling the conical shaped tree. Ordinarily, the wires used in this purpose are typically straight, and easy to be entangled with each other or with the tree body, especially when the artificial trees are in storage. As a result, detaching the wires from the artificial trees is another headache for the user. Even worse, some wires are incorporated with spaced apart flashing lights, which are easy to be broken. Therefore, a relatively large amount of storage space is necessary when the artificial trees are not being used.

As a result, it is highly desirable to design an artificial Christmas tree, which is easy to set up, convenient to assemble and disassemble, automatically stable, compact for storage, and simply accessible to decorative ornaments.

### SUMMARY OF THE PRESENT INVENTION

A main object of the present invention is to provide a foldable Christmas tree, which is easy to set up, automatically stable, convenient to assemble and disassemble, compact for storage.

Another object of the present invention is to provide a foldable Christmas tree, wherein components for forming such Christmas tree are minimized thus facilitating the erecting and disassembling process, as well as manufacturing costs.

Another object of the present invention is to provide a foldable Christmas tree, which is capable of being positioned in many ways to be placed in a variety of spaces, such as being hanged on a wall or being disposed tightly against a corner.

Another object of the present invention is to provide a foldable Christmas tree, wherein the disassembled components of such Christmas tree are capable of being piled up for minimizing the storage space.

Another object of the present invention is to provide a foldable Christmas tree, wherein no long wires are required for helically encircling such Christmas tree to attach decorative ornaments and provide illuminative effects. Instead, the foldable Christmas tree is capable of supporting a multiplicity of ornaments by its inherent structure.

Another object of the present invention is to provide a foldable Christmas tree, wherein no further fixing device is applied for ensuring said Christmas tree steadfastly immovable. The foldable Christmas tree is free standing and remaining upright.

Accordingly, to achieve above mentioned objects, the present invention provide a foldable decorative Christmas tree, which comprises:

a tree body comprising at lease two leaf panels, each of which has a longitudinal inner side, and a shaped outer side;

means for hanging the leaf panel at the inner side thereof in such a manner the outer side of the leaf panel is capable of pivotally folding along the inner side of the leaf panel; and

means for binding the leaf panels at the outer side thereof so as to retain an angular angle between any two of the leaf panels.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a foldable Christmas tree according to the first preferred embodiment of the present invention.

FIG. 2 is side view of the tree panel according to the above preferred embodiment of the present invention.

FIG. 3 is a perspective view of the foldable Christmas tree according to the above preferred embodiment of the present invention showing the tree is in a foldable manner.

FIG. 4 is a perspective view of the foldable Christmas tree according to the above preferred embodiment of the present invention showing the tree is disposed against a corner.

FIG. 5 is a perspective view of the foldable Christmas tree according to the above preferred embodiment of the present invention showing the tree is hung on a wall.

FIG. 6 is exploded perspective view of the foldable decorative tree according to the above preferred embodiment of the present invention showing the illumination arrangement and reinforcing base.

### DETAILED DESCRIPTION OF THE PREFERRED EMBODIMENT

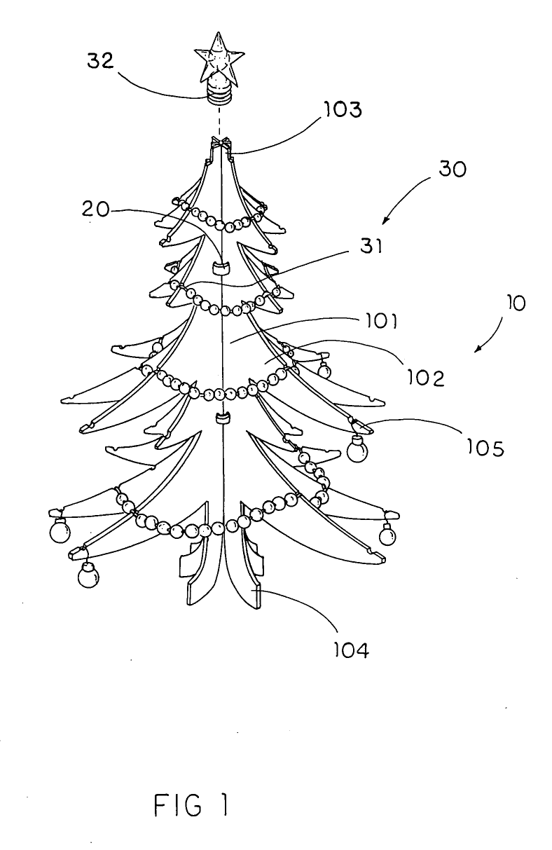

Referring to the FIG. 1 to FIG. 3, the foldable Christmas tree according to the first preferred embodiment of the present invention is illustrated. The foldable Christmas tree comprises a tree body 1 which comprises at least two tree panels 10, each of which comprises an inner centerline edge 101 and a shaping outer edge 102.

The foldable decorative tree further comprises at least a folding unit 20 provided at the centerline edges 101 of said tree panels 10 to pivotally attach the tree panels 10 each other, wherein the tree body 1 is adapted to fold between a setup position and a folded position, wherein at said setup position, the tree panels are pivotally folded to radially extend along said centerline edges thereof, and at said folded position, said tree panels are folded to overlapped with each other to form a compact structure.

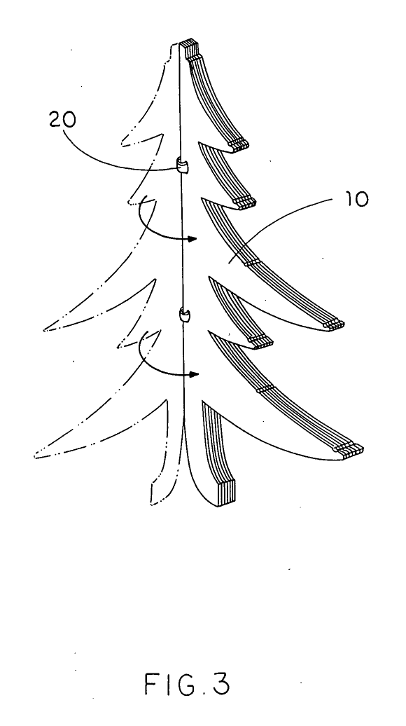

In other words, by pivotally folding the outer shaping edges 102 of the tree panels 10 along the inner centerline edge 101, the tree body 1 of the foldable Christmas tree is capable of being stacked together as a loose-leaf book for storage as shown in FIG. 3. On the other hand, the folded tree body 1 is capable of being radially extended to form an erection as shown in FIG. 1.

Moreover, the folding unit 20 has a plurality of folding slots 1011 alignedly formed at the centerline edges 101 of the tree panels 10 respectively and a folding ring 1012 mounted to the centerline edges 1011 of the tree panels 10 though the folding slots 1011 to pivotally connect the tree panels 10.

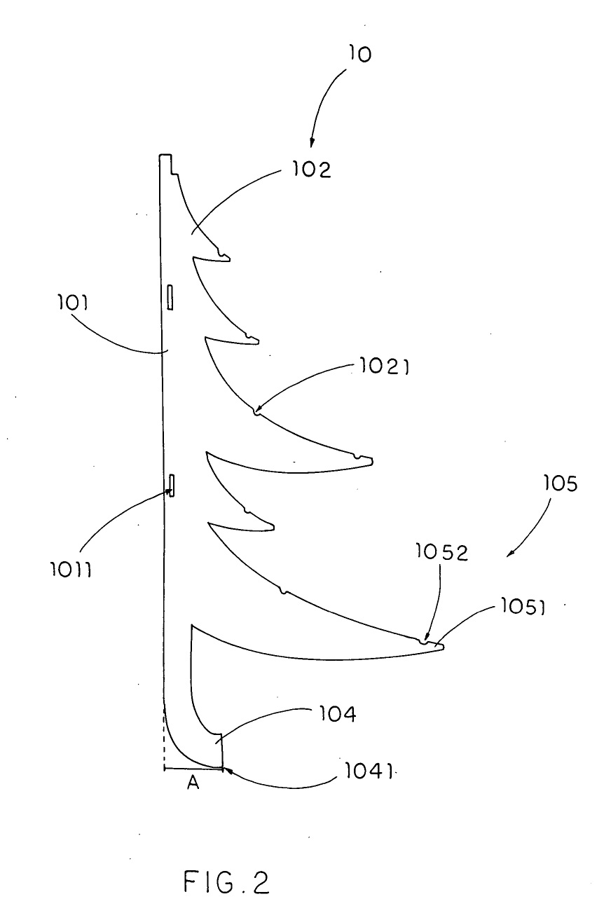

According to the preferred embodiment of the present invention, the centerline edges 101 of tree panels 10 are straightly linear shaped. As shown in FIG. 2, the plurality of folding slots 1011 are spacedly defined in a position adjacent to the margin of the centerline edge 101, so that by inserting the folding ring 1012 through the folding slots 1011, the tree panels 10 are capable of being bound together.

As a result, the tree body 1 of the foldable decorative tree of the present invention could be folded as a stack of tree panels 10 like a loose-leaf paper binder with one edge binding together. While for application, the user could merely erect the stacks of tree panels 10, and then radially dispose the tree panels 10 as an explodedly formed standing erection.

It is noted after the tree panels 10 are radially disposed for erecting the tree body 1, the tree panels 10 here in the present invention are just like a plurality of radially spaced spokes standing from an axis formed by the centerline edges 101 of the tree body 1.

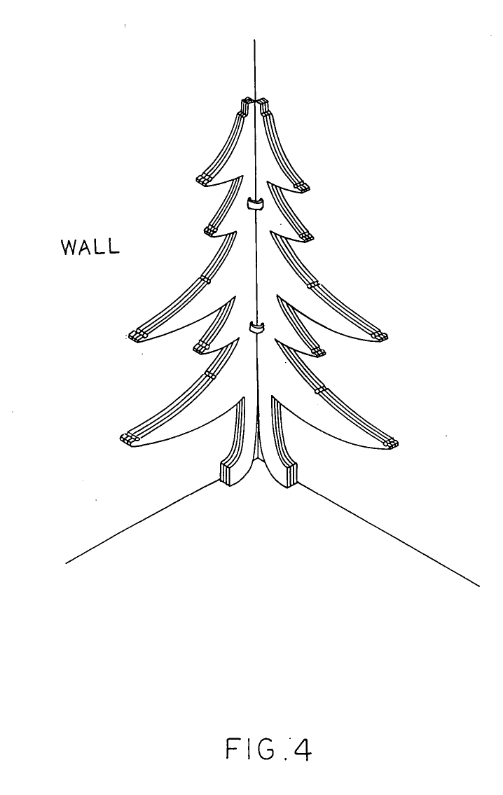

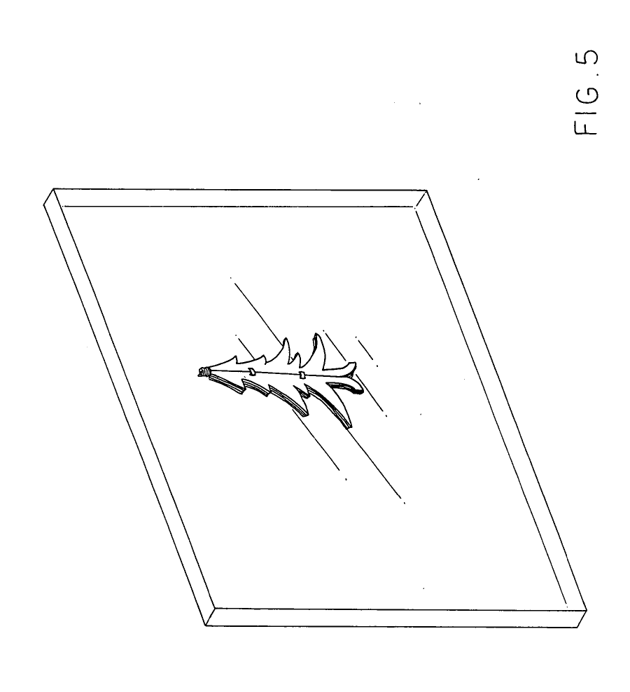

Moreover, the shape of foldable decorative tree is purposely maneuvered by the user. This is to say that under different circumstances, the users are able to dispose the tree panels 10 into different variations, such as a fan-shape for positioning the foldable decorative tree to a corner as shown in FIG. 4, or a semicircular shape for hanging the foldable decorative tree on a wall as shown in FIG. 5.

Here, the folding ring 1012 could be embodied as conventional fastening element, such as strings, loops, straps, fasteners, latches, buckled belts and so on.

It is noted that tree panel panels 10 are made of lightweight materials, such as rigid plastic, organic glasses, hard woods, lightweight metals and so on, so that the maneuverability of the tree body 1 is convenient to the users. During a routine application, a user may erect the tree body 1 of the foldable decorative tree first, and then radially array the tree panels 10 into a round shape or a fan shape to set up a Christmas tree.

The foldable Christmas tree further comprises an angular locker 30 which has a plurality of locking notches 1021 spacedly formed at the shaping edges 102 of the tree panels 10 and comprises an elongated element 31 fastening at the shaping edges 102 of the tree panels 10 at the locking notches 1021 to encircle the tree body 1 so as to retain the tree panels 10 in position.

That is to say, the angular locker 30 is provided for binding the tree panels 10 at the shaping edge 102 thereof so as to retain an angular angle between any two of the tree panels 10.

Furthermore, the angular locker 30 further comprises a plurality of decorative elements 32 mounted along the elongated element 31 such that the decorative elements 32 positioned at each two shaping edges 102 of the tree panels 10 is capable of retaining said tree panels 10 in position.

According to the preferred embodiment of the present invention, the elongated element 31 are a plurality of ring-shaped wires mounted on the locking notches 1021 defined on the shaping edge 102 of the tree panel 10 for retaining an angular angle between any two of individual tree panels 10 for hanging some decorative merchandise. Preferably, at least one locking notch 1021 is defined on the shaping edge 102 of the tree panel 10 for mounting the ring-shaped elongated element 31. As a result, the ring-shaped wires are manually removable in a vertical direction relative to the tree body 1 allowing the ornaments placed on the Christmas tree being easily detached therefrom. It is worth to mention that the augular locker 30 could be embodied as a plurality of beads stringed together for holding the tree panels 10 retained in position as shown in FIG. 1.

According to the preferred embodiment of the present invention, each tree panel 10 is identically shaped. As a result, the separate closure ring-shaped elongated element 31 is capable of encirclingly mounting on the tree body 1 to reinforce the tree structure. What is more, the ring-shaped elongated element 31 provides a ready attaching place for attaching decorative ornaments.

As seen in FIG. 2, the tree panel 10 is a longitudinal extension having a shaping edge 102. This is to say that the shaping edge 102 has a predetermined nonlinear shape, wherein a plurality of protrusions 105 is defined on the shaping edge 102 for directly attaching ornamental merchandises. In the present invention, each distal 1051 of the protrusions 105 is defined to recess a hanging notch 1052 for directly hanging some attachments.

In short, this present invention just utilizes a plurality of tree panels 10 radially disposed to form an erection. And the tree panels 10 are defined to have a nonlinear shaping edge 102 on which a plurality of locking notch 1021 is etched for mounting loop-shaped elongated element 31. Furthermore, the shaping edge 102 has a plurality of protrusion 105 functioned as a hanger for attaching electric wires or other decorative merchandises. When in storage, tree panels 10 are folded and bound together as a book shape, whenever for erection, each individual tree panel 10 is radially arrayed to form the tree body 1.

Additionally, each of the tree panels 10 has bottom leg portion 104 outwardly extending from the centerline edge 101 thereof, wherein when the tree panels 10 are pivotally folded at the setup position, the leg portions 104 of the tree panels 10 will automatically form a tree stand for supporting on a ground surface.

For stabilization reason, the bottom leg portion 104 is inclinedly and outwardly curved. As a result, after the tree body 10 is unfolded to form an erection, the tree panels 10 are radially disposed. As shown in FIG. 1 and FIG. 2, the bottom leg portion 104 is functioned as a footing having a supporting point 1041 which is adaptive to contact with ground or whatever supporting means, such as a table top surface, for standing the tree body 1. To ensure the foldable decorative tree 1 steadfastly immoveable, the supporting point 1041 of the bottom leg portion 104 is apart from the axis of the tree body 1 thereby defining a predetermined distance A from the supporting point 1041 to the axis of the tree body as shown in the FIG. 2.

It is worth to mention at least three leaf panels 10 are minimally required for maintaining the tree body 1 stable according to the geometric law, and the distance from the supporting point 1041 and centerline edge 101 is proportionally designed with respect to the height of the tree body 1 for a security reason. It is worth mentioning that when the tree body 1 is disposed against a corner, only two leaf panels 10 are minimally required.

The foldable Christmas tree further comprises a top locker 32 detachably attaching to upper ends of said tree panels 10 to substantially retain the tree body 1 at the setup postion. According to the preferred embodiment of the present invention, each of the tree panel 10 further comprises a tipped top end 103. The top locker 32 is embodied as a coil shaped fastener 32 disposed on the tipped top end 103 of the tree panel 10. It is seen that one sharp end of fastener 321 is upwardly extended to form a pin. So the fastener 32 not only functions for reinforcing the structure of the tree body, but also functions as a stand for nestling an ornamental element, such as a decorative star.

The foldable Christmas tree further comprises a ground stand 22 having a ring shape has a plurality of engaging slots 222 spacedly formed thereon wherein the bottom leg portions 104 of the tree panels 10 are slidably mounted to the engaging slots 222 respectively to support the tree body 1 on the ground stand 22 so as to substantially hold the tree panels 10 in position.

It is noted that the width of the engaging slot 222 is slightly wider than the thickness of the tree panel 10 for ensuring the tree panel 10 being inserted into the engaging slots 222. At the same time, the engaging slots 222 are heavily dispersed around the loop shaped ground stand 22, thus the user could intentionally choose some predetermined engaging slots 222 to insert into corresponding tree panel 10. As a result, by unevenly inserting the tree panel 10 into a predetermined portion of the engaging slots 222, the foldable Christmas tree is adaptive to be positioned against a corner.

The foldable Christmas tree further comprises a lighting system which comprises a center electric extension 50 upwardly extended along the centerlines of the tree panels 10 and a plurality of terminal illuminators 51 radially extended from the center electric extension 50 towards the shaping edges 102 of the tree panels 10 for providing a lighting effect for the tree body 1 when the center electric extension 50 is powered on.

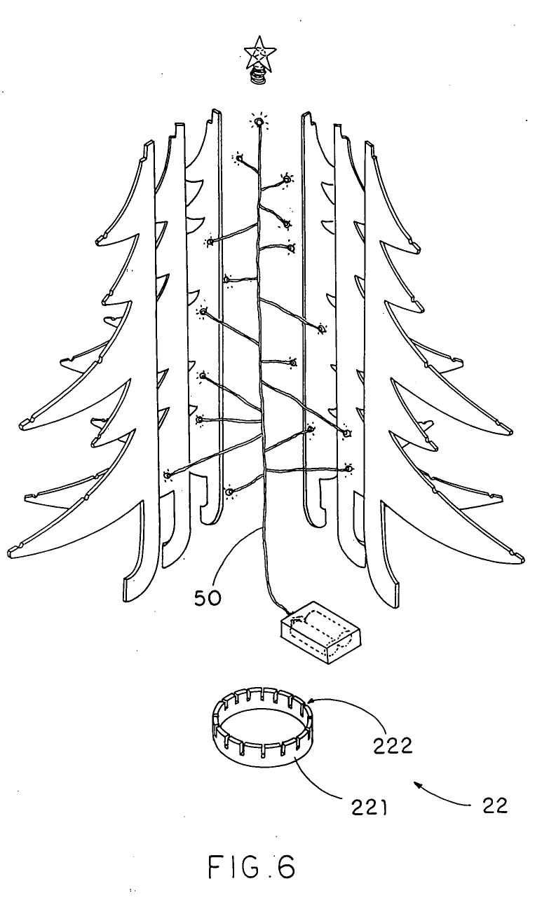

Additionally, according to the first preferred embodiment of the present invention, the center electric extension 50 is extended upwardly from below continuously till the top end 103 thereof for providing some illumination effects, and is electrically connected with a power source, preferably, a heavy-duty battery unit. Therefore, the center electric extension 50 could be further expended to be attached on the separated angular locker 30 for providing some sorts of illumination effects as shown in FIG. 6.

Preferably, the center electric extension 50 is made of common electrical wire, so such lighting system will not impact the overall appearance of the foldable Chirstmas tree. And each of the terminal illuminators 51 is embodied as a medium sized electrical bulb. As a result, the lighting system could be associated with a further chain-lighting system to generate a multiple illuminating effects.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure form such principles. Therefore, this invention includes all modifications encompassed within the spirit and scope of the following claims.

What is claimed is:

1. A foldable Christmas tree, comprising:
a tree body comprising at lease two leaf panels, each of which has an inner centerline edge and an outer shaping edge; and
at least a folding unit provided at said centerline edges of said tree panels to pivotally attach said tree panels each other, wherein said tree body is adapted to fold between a setup position and a folded position, wherein at said setup position, said tree panels are pivotally folded to radially extend along said centerline edges thereof, and at said folded position, said tree panels are folded to overlapped with each other to form a compact structure.

2. The foldable Christmas tree, as recited in claim 1, wherein said folding unit has a plurality of folding slots alignedly formed at said centerline edges of said tree panels respectively and a folding ring mounted to said centerline edges of said tree panels though said folding slots to pivotally connect said tree panels.

3. The foldable Christmas tree, as recited in claim 2, wherein said folding unit has a plurality of folding slots alignedly formed at said centerline edges of said tree panels respectively and a folding ring mounted to said centerline edges of said tree panels though said folding slots to pivotally connect said tree panels.

4. The foldable Christmas tree, as recited in claim 1, further comprising an angular locker which has a plurality of locking notches spacedly formed at said shaping edges of said tree panels and comprises an elongated element fastening at said shaping edges of said tree panels at said locking notches to encircle said tree body so as to retain said tree panels in position.

5. The foldable Christmas tree, as recited in claim 2, further comprising an angular locker which has a plurality of locking notches spacedly formed at said shaping edges of said tree panels and comprises an elongated element fastening at said shaping edges of said tree panels at said locking notches to encircle said tree body so as to retain said tree panels in position.

6. The foldable Christmas tree, as recited in claim 3, further comprising an angular locker which has a plurality of locking notches spacedly formed at said shaping edges of said tree panels and comprises an elongated element fastening at said shaping edges of said tree panels at said locking notches to encircle said tree body so as to retain said tree panels in position.

7. The foldable Christmas tree, as recited in claim 4, wherein said angular locker further comprises a plurality of decorative elements mounted along said elongated element such that said decorative elements are positioned each two said shaping edges of said tree panels to retain said tree panels in position.

8. The foldable Christmas tree, as recited in claim 5, wherein said angular locker further comprises a plurality of decorative elements mounted along said elongated element such that said decorative elements are positioned each two said shaping edges of said tree panels to retain said tree panels in position.

9. The foldable Christmas tree, as recited in claim 6, wherein said angular locker further comprises a plurality of decorative elements mounted along said elongated element such that said decorative elements are positioned each two said shaping edges of said tree panels to retain said tree panels in position.

10. The foldable Christmas tree, as recited in claim 1, wherein each of said tree panels has bottom leg portion outwardly extending from said centerline edge thereof, wherein when said tree panels are pivotally folded at said setup position, said leg portions of said tree panels form a tree stand for supporting on a ground surface.

11. The foldable Christmas tree, as recited in claim 3, wherein each of said tree panels has bottom leg portion outwardly extending from said centerline edge thereof, wherein when said tree panels are pivotally folded at said setup position, said leg portions of said tree panels form a tree stand for supporting on a ground surface.

12. The foldable Christmas tree, as recited in claim 6, wherein each of said tree panels has bottom leg portion outwardly extending from said centerline edge thereof, wherein when said tree panels are pivotally folded at said setup position, said leg portions of said tree panels form a tree stand for supporting on a ground surface.

13. The foldable Christmas tree, as recited in claim 9, wherein each of said tree panels has bottom leg portion outwardly extending from said centerline edge thereof, wherein when said tree panels are pivotally folded at said setup position, said leg portions of said tree panels form a tree stand for supporting on a ground surface.

14. The foldable Christmas tree, as recited in claim 1, further comprising a ground stand having a ring shape has a plurality of engaging slots spacedly formed thereon wherein said leg portions of said tree panels are slidably mounted to said engaging slots respectively to support said tree body on said ground stand so as to substantially hold said tree panels in position.

15. The foldable Christmas tree, as recited in claim 9, further comprising a ground stand having a ring shape has a plurality of engaging slots spacedly formed thereon wherein said leg portions of said tree panels are slidably mounted to said engaging slots respectively to support said tree body on said ground stand so as to substantially hold said tree panels in position.

16. The foldable Christmas tree, as recited in claim 9, further comprising a ground stand having a ring shape has a plurality of engaging slots spacedly formed thereon wherein said leg portions of said tree panels are slidably mounted to said engaging slots respectively to support said tree body on said ground stand so as to substantially hold said tree panels in position.

17. The foldable Christmas tree, as recited in claim 1, further comprising a top locker detachably attaching to upper ends of said tree panels to substantially retain said tree panels at said setup postion.

18. The foldable Christmas tree, as recited in claim 16, further comprising a top locker detachably attaching to upper ends of said tree panels to substantially retain said tree panels at said setup postion.

19. The foldable Christmas tree, as recited in claim 1, further comprising a lighting system which comprises a center electric extension upwardly extended along said centerlines of said tree panels and a plurality of illuminators radially extended from said center electric extension towards said shaping edges of said tree panels for providing a lighting effect for said tree body when said center electric extension is powered on.

20. The foldable Christmas tree, as recited in claim 18, further comprising a lighting system which comprises a center electric extension upwardly extended along said centerlines of said tree panels and a plurality of illuminators radially extended from said center electric extension towards said shaping edges of said tree panels for providing a lighting effect for said tree body when said center electric extension is powered on.
